(19) United States
(12) Patent Application Publication
(10) Pub. No.: US 2014/0183311 A1
(43) Pub. Date: Jul. 3, 2014

(54) Tree Planter Harness

(71) Applicant: JOHN JOSEPH PETERSON, Paramus, NJ (US)

(72) Inventor: John Joseph Peterson, Paramus, NJ (US)

(73) Assignee: John Joseph Peterson, Paramus, NJ (US)

(21) Appl. No.: 13/729,028

(22) Filed: Dec. 28, 2012

(51) Int. Cl. A01G 9/12

(52) U.S. Cl. CPC A01G 9/128
USPC 248/218.4

(57) ABSTRACT

The Tree Planter Harness is an apparatus which supports and holds in an elevated or ground level position a planter or planters around and adjacent to the circumference of an upright tree trunk for the purpose of growing or retaining plants.

### CROSS-REFERENCE TO RELATED APPLICATIONS

Based upon Non Provisional Patent Application No. 61/580,985 dated Dec. 28, 2011.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

### Field of the Invention

Not aplicaple

### BRIEF SUMMARY OF THE INVENTION

The Tree Planter Harness is an apparatus which supports and holds in an elevated or ground level position a planter or planters around the circumference of an upright tree trunk for the purpose of growing or retaining plants. The harness utilizes a flexible belt like material to hold and retain the apparatus in place. The natural non conformances and natural growth taper of tree trunk (larger at the bottom and tapering smaller as the tree progresses upward)prevents the harness from falling or slipping downward thus retaining the harness in place on the tree trunk. The sub components of the harness shown as retaining harnesses retain the planters in a vertical position. The main harness and retaining harnesses are adjustable to be receptive to many sizes and shapes of tree trunks and planters. The retaining harnesses may or may not be used if a planter has a provision to support itself to the main harness.

### BRIEF DESCRIPTION OF THE SEVERAL VIEWS OF THE FIGURES

FIG. I is an auxiliary view of the harness and the subcomponents.

FIG. II is an auxiliary view of a tree trunk with the tree planter harness and the tree planter harness subcomponents.

FIG. Is an assembly drawing of the planters and harness along with totally assembled harness with planters.

### DETAILED DESCRIPTION OF THE INVENTION

The Tree Planter Harness is an apparatus which supports and holds in an elevated position a planter or planters around the circumference of an upright tree trunk for the purpose of growing or retaining plants.

The Main Support Harness (101) purpose is to support and hold in position the planters via the planter retaining harness (104) or harnesses around the circumference of an upright tree trunk. The planter retaining harness, support and retain planters in an elevated position or at ground level around the circumference of an upright tree trunk or trunks. The Planter retaining harness may not be used if the planter has been made or adapted to be retained by the main support harness. The planters are used to grow plants, flowers and such or to hold artificial ornaments or plants.

The Main Support Harness 101 is constructed of an open ended flexible belt, belt like, strap or strap like material and an adjustment connecting fastener 102, which will allow the two open ends to be connected to each other after both ends encompass a tree trunks diameter thus creating one complete closed adjustable loop. The adjustment in the loop size (Diameter) which can be made larger or smaller is necessary to accommodate a wide variety of tree trunk diameters. Two or more main support harnesses may be linked together to accommodate larger tree diameters.

The main Support Harness is positioned around a tree trunks diameter by encompassing one opened end of the harness to the left side of the tree trunk diameter and encompassing the other open end of the harness to the right side of the tree trunk diameter, the two open ends are connected together (using the fastener) around the tree truck thus creating a complete enclosed harness loop surrounding the tree trunk diameter. The tension of the harness is adjusted in the direction of the tightening position against the diameter of the tree trunk. The tightened harness is not only relying upon the tension of the harness against the tree trunk diameter but also utilizes the natural non-conformances of the tree trunk as well as the natural growth taper of the tree trunk as being larger towards the bottom and naturally and slowly tapers narrower moving upward on the tree trunk, thus supporting itself from falling downward The Main Support Harness's length or when the two ends are connected diameter is made adjustable via the connecting and adjustment fastener and or a hook and loop fastener (Velcro).

The Main Support Harness 101 retains other secondary components called the Planter Retaining Harness. The Planter Retaining Harness 104 or harnesses 104 are attached to the main support harness 101 either permanently or made detachable.

The Planter Retaining Harness or Harnesses 104 is constructed of a flexible belt, belt like, strap or strap like material and is adjustable via 105 an adjustment fastener and or a hook and loop material (Velcro)) unless otherwise constructed to a fixed size or diameter when called for on special production applications. The Planter Retaining Harness is flexible and adjustable similar to a waste line belt thus the area in the center area (the loop)of the Planter Retaining Harness can be adjusted to be smaller or larger, this adjustment is achieved using its subcomponent 102 (an adjustment fastener and or a hook and loop fastener(Velcro). The adjustment of the loop of the Planter Retaining Harness is necessary to accommodate different size, configuration and shape planters. The retaining harness utilizes the taper, and or the rimmed diameter or the rolled top edge of the planter to support the planter in the elevated position.

The Planter Retaining Harness's (104) position relative to the Main Support Harness's (101) encompassed circumference is adjustable along the circumference or otherwise the length of the Main Support Harness 101.

### Figures

FIG. I, shows in an auxiliary view the harness and the harness subcomponents in a closed assembled position. 101 Main Support Harness, 102 Connecting and Adjustment Fastener, 103 Adjustable attaching fastener, 104 Planter Retaining Harness, 105 Adjustment Fastener. The Main Support Harness 101 retains the Planter Retaining Harnesses. The Planter Retaining Harnesses are sub components of the main support harness. All secondary components are attached to the main support harness 101 either permanently or made detachable.

(The Planter Retaining Harness) 104 is constructed of a flexible belt, belt like, strap or strap like material and is adjustable via 105 an adjustment fastener and or a hook and loop material (Velcro)) unless otherwise constructed to a fixed size or diameter when called for on special production applications . The Planter Retaining Harness is flexible and adjustable similar to a waste line belt thus the area in the center area (the loop)of the Planter Retaining Harness can be adjusted to be smaller or larger, this adjustment is achieved using its subcomponent 102 (an adjustment fastener and or a hook and loop fastener (Velcro). The adjustment of the loop of the Planter Retaining Harness is necessary to accommodate different size, configuration and shape planters. The retaining harness utilizes the taper, and or the rimmed diameter or the rolled top edge of the planter to support the planter in the elevated position.

The Planter Retaining Harness's (104) position relative to the Main Support Harness's (101) encompassed circumference is adjustable along the circumference or otherwise the length of the Main Support Harness 101.

FIG. II, shows in perspective and an auxiliary view the complete harness and the harness subcomponents assembled with planters around the circumference of a tree trunk.

FIG. III, is an assembly drawing of the harness and the planters and a drawing of the completed assembly without the tree trunk.

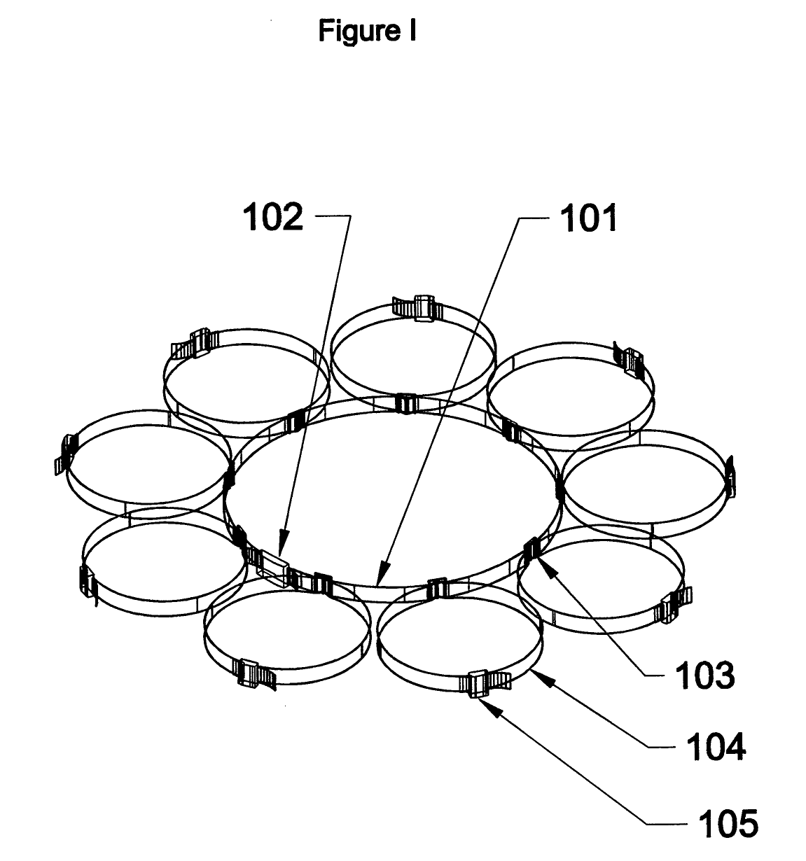

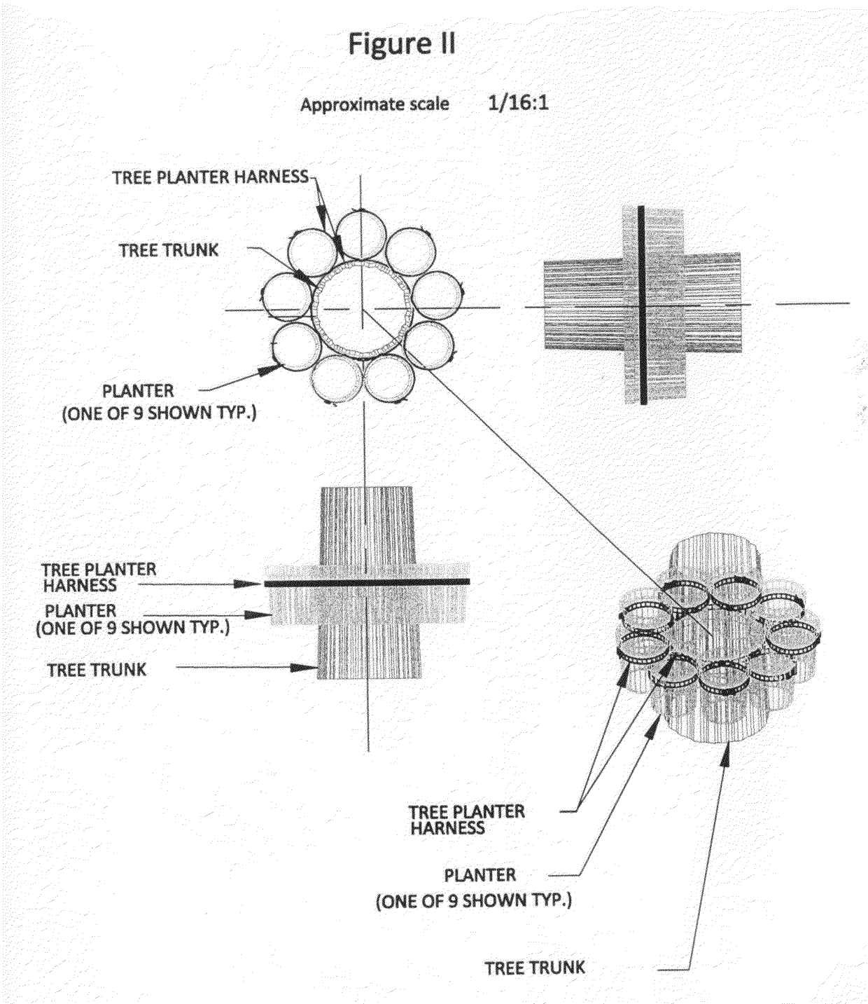

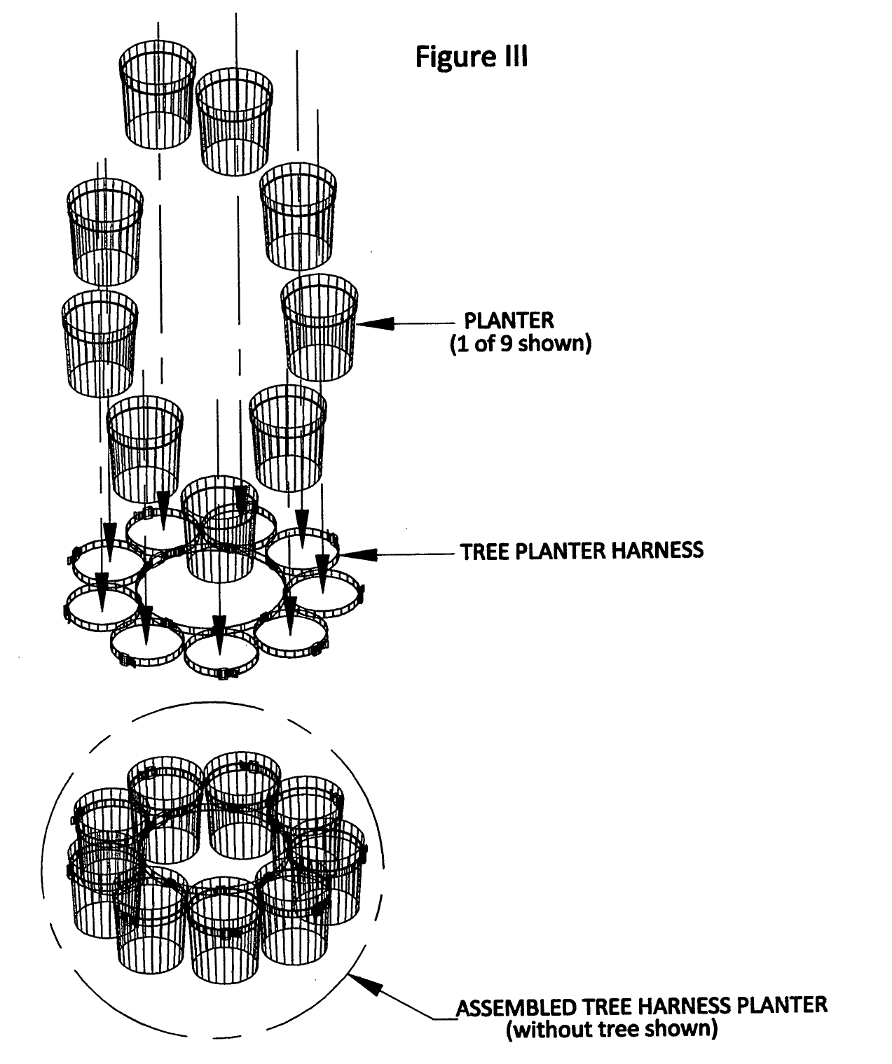

Figures. 3 sheets.

### SEQUENCE LISTING

Not Applicable

1: (canceled)

2: (canceled)

3: (canceled)

4: (canceled)

5: (canceled)

6: (canceled)

7: (canceled)

8: (canceled)

9: (canceled)

10: (canceled)

11. A method of using a harness system for at least one planter comprising:
feeding a first end of a main support harness of a tree planter harness around one side of a secondary object,
wherein the tree planter harness comprises,
at least one main support harness having two ends with each of the two ends having a complimentary connecting and adjustment fastener,
wherein the two ends are connected via the connecting and adjustment fastener forming a main loop having a first length and
wherein the length of the main loop is adjustable,
at least one planter retaining harness coupled to the at least one main support harness having two ends with each of the two ends having a complimentary connecting and adjustment fastener,
wherein the two ends are connected via the connecting and adjustment fastener forming a secondary loop having a second length and
wherein the length of the secondary loop is adjustable,
an adjustable attaching fastener that couples the at least one planter retaining harness to the at least one main support harness,
feeding a second end of the main support harness around the other side of the secondary object;
securing the first end to the second end using a connecting and adjustment fastener;
adjusting the height of the main support harness around the secondary object;
tightening the main support harness around the periphery of the secondary object;
feeding a first end of a planter retaining harness around one side of a planter;
feeding a second end of the planter retaining harness around the other side of the planter;
securing the first end to the second end using a connecting and adjustment fastener; and
tightening the planter retaining harness around the periphery of the planter.

12. The method of claim 11 further comprising the steps of:
feeding a first end of a planter retaining harness around one side of a second planter;
feeding a second end of the planter retaining harness around the other side of the second planter;
securing the first end to the second end using a connecting and adjustment fastener; and
tightening the planter retaining harness around the periphery of the second planter.

13. The method of claim 12 wherein the first feeding through the tightening steps are repeated for each additional planter after the second planter.

14. The method of claim 11 wherein the tightening of the main support harness is achieved via the connecting and adjustment fastener.

15. A harness system for holding at least one planter in an elevated position comprising:
a tree planter harness comprising,
at least one main support harness having two ends with each of the two ends
having a complimentary connecting and adjustment fastener,
wherein the two ends are connected via the connecting and adjustment fastener forming a main loop having a first diameter and
wherein the diameter of the main loop is adjustable,
at least one planter retaining harness coupled to the at least one main support harness having two ends with each of the two ends having a complimentary connecting and adjustment fastener,
wherein the two ends are connected via the connecting and adjustment fastener forming a secondary loop having a second diameter and
wherein the diameter of the secondary loop is adjustable,
an adjustable attaching fastener that couples the at least one planter retaining harness to the at least one main support harness; and
at least one planter,
wherein the planter is positioned within and held by the secondary loop of the at least one planter retaining harness.

16. The harness system of claim 15 wherein the main loop of the tree planter harness is positioned around the trunk of a tree.

17. The harness system of claim 15 wherein the at least one planter holds an artificial or natural plant or plants.

18. The harness system of claim 15 wherein there are between about 1 to about 15 planter retaining harnesses and more preferably about 3 to about 9 planter retaining harness disposed along the circumference of the main support harness.

19. The harness system of claim 18 wherein there is one planter for each planter retaining harness.

20. The harness system of claim 15 wherein the position of the at least one planter retaining harness is adjustable along the circumference of the at least one main support harness.

21. The harness system of claim 15 wherein the secondary loop has a smaller diameter than the main loop.

22. A harness system for holding at least one planter in an elevated position comprising:
a tree planter harness comprising,
at least one main support harness having two ends with each of the two ends having a complimentary connecting and adjustment fastener,
wherein the two ends are connected via the connecting and adjustment fastener forming a main loop and
wherein the length of the main loop is adjustable, more than one planter retaining harnesses removably coupled to the at least one main support harness having two ends with each of the two ends having a complimentary connecting and adjustment fastener,
wherein the two ends are connected via the connecting and adjustment fastener forming a secondary loop and
wherein the length of the secondary loop is adjustable, an adjustable attaching fastener that couples the at least one planter retaining harness to the at least one main support harness,
wherein there is at least one adjustable attaching fastener for each planter retaining harness;
more than one planter configured to hold plants, ornamental objects, or a combination thereof,
wherein the planter is positioned within and held by the secondary loop of the at least one planter retaining harness; and
a secondary object which provides support for and frictionably engages the at least one main support harness,
wherein the length of the main loop is adjusted in relation to the perimeter of the secondary object to provide the desired support.

23. The harness system of claim 22 wherein there are between about 1 to about 15 planter retaining harnesses and more preferably about 3 to about 9 planter retaining harness disposed along the circumference of the main support harness.

24. The harness system of claim 22 wherein the length of the main support harness is greater than the length of any of the planter retaining harness.

25. The harness system of claim 22 wherein the length of the main support harness is less than the length of any of the planter retaining harness.

26. The harness system of claim 22 wherein the planter retaining harnesses are detachable from the main support harness.

27. The harness system of claim 22 wherein the planter retaining harness and main support harness comprise a flexible material.
